(19) United States
(12) Patent Application Publication
(10) Pub. No.: US 2025/0383472 A1
(43) Pub. Date: Dec. 18, 2025

(54) TOOL AND METHODS FOR EVALUATING A QUALITY OF A GEOLOGICAL MODEL

(71) Applicant: SAUDI ARABIAN OIL COMPANY, Dhahran (SA)

(72) Inventors: Nauman AQEEL, Dhahran (SA); Yahya AL-GHUWAIDI, Dhahran (SA); Heba AL-MANA, Dhahran (SA)

(73) Assignee: SAUDI ARABIAN OIL COMPANY, Dhahran (SA)

(21) Appl. No.: 18/745,595

(22) Filed: Jun. 17, 2024

(51) Int. Cl. G01V 20/00

(52) U.S. Cl. CPC G01V 20/00

(57) ABSTRACT

Systems and methods are disclosed relating to evaluating a quality of a geological model of a reservoir. A model well top table can be generated based on a horizon of the geological model. An original well top table can be based on input data that can include normal logs and formation, evaluation, and analysis (FAL)) logs for the reservoir. The model well top table and the original well top table can be merged to provide a unified properties table. The quality of the geological model can be evaluated using the unified properties table.

### FIELD OF THE DISCLOSURE

This disclosure relates generally to quality analysis and control, and more particularly, evaluating a quality of a geological model.

### BACKGROUND OF THE DISCLOSURE

Geological models (e.g., geocellular models) are used to digitally represent subsurface geological structures, properties, and/or distributions of rock and fluid contents within a reservoir. A reservoir is a subsurface geological formation that can contain hydrocarbons, such as oil, natural gas, or both. A subsurface can include anything beneath a surface. The subsurface can encompass geological layers, formations, and structures that exist below ground level, including, but not limited to, the reservoir. Geological models can be constructed to assess a geometry, composition, porosity, permeability, and/or fluid distribution within the reservoir, which can be used to predict how fluids (e.g., oil, gas, and/or water) will move within rock formations.

To create or generate a geological model, reservoir software can be used. The process begins with the reservoir software constructing a structural model. The structural model is a three-dimensional (3D) model of a reservoir subsurface and can include geological structures, such as fault networks and stratigraphic layers. The reservoir software, after constructing the structural model, can divide the reservoir software into a grid. The grid can be structured or unstructured, with cells that contain property data. For example, the reservoir software can populate the grid with the property data, which can include geological properties (e.g., one or more of porosity, permeability, etc.). Geostatistical methods can be used to estimate (e.g., interpolate) property values across the grid, estimating between known points from well locations. The reservoir software can upscale the geological model to adjust a simulation scale. Because reservoir simulations require a coarser grid than a detailed version of the geological model (e.g., prior to upscaling), upscaling averages properties of fine-scale cells to match a simulation grid's coarser scale. Following upscaling, the geological model can be simulated using a reservoir simulator (or the reservoir software) to predict fluid movement within the reservoir over time under one or more different production scenarios.

### SUMMARY OF THE DISCLOSURE

Various details of the present disclosure are hereinafter summarized to provide a basic understanding. This summary is not an extensive overview of the disclosure and is neither intended to identify certain elements of the disclosure nor to delineate the scope thereof. Rather, the primary purpose of this summary is to present some concepts of the disclosure in a simplified form prior to the more detailed description that is presented hereinafter.

According to an embodiment, a method can include generating, by a processor, a model well top table based on a horizon of the geological model, generating, by the processor, an original well top table based on input data comprising normal logs and formation, evaluation, and analysis (FAL)) logs for the reservoir, merging, by the processor, the model well top table and the original well top table to provide a unified properties table, and evaluating, by the processor, the quality of the geological model using the unified properties table.

In another embodiment, a method can include generating, by a processor, a model well logs table based on the geological model, generating, by the processor, an original well logs table based on logs captured for the reservoir, merging, by the processor, the model well logs table and the original well logs table to provide a unified log table; and evaluating, by the processor, the quality of the geological model using the unified log table.

According to another embodiment, a system can include a tool that can include a map points table generator to generate a map points table based one or more maps provided based on the geological model, a well top table generator to generate a model well top table based on the geological model and generate an original well top table based on input data, a log table generator to generate a model well logs table based on the geological model and generate an original well logs table based on logs captured for the reservoir, a table merger to merge the model well top table, the original well top table and the map points table to provide a unified properties table and merge the model well logs table and the original well logs table to provide a unified log table, an analyzer to evaluate a quality of the geological model using one of the unified properties table and the unified log table and provide analysis results data, and a graphical user interface (GUI) generator to provide a GUI based on the analysis results data for rendering on an output device.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is an example of a block diagram of a tool for evaluating a quality of a geological model.

FIG. 2 is an example of a method for evaluating a quality of a geological model.

FIG. 3 is an example of a portion of a workflow developed in a reservoir software.

FIG. 4 is an example of a model well top table.

FIG. 5 is an example of an original well top table.

FIGS. 6-7 are example screens of a workflows that can be provided by the tool.

FIGS. 8A-8B are further example screens that can be provided by the tool.

FIG. 9 is an example of a data integration diagram.

FIG. 10 is an example of a table representing a portion of a unified table.

FIGS. 11-12 are examples of additional screens of an analysis dashboard graphical user interface (GUI) that can be provided by the tool.

FIG. 13 is an example of pseudocode for providing cumulative horizontal permeability and porosity per well for plot generation.

FIGS. 14-19 are examples of further screens of the GUI that can be provided by the tool.

FIG. 20 is a block diagram of a system that can be used to perform one or more methods according to an aspect of the present disclosure.

FIG. 21 is an example of a cloud computing environment that can be used to perform one or more methods according to an aspect of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Examples are disclosed herein relating to quality control (QC) and/or assessment (QC/QA) of a geological model (e.g., a geocellular model). Geological model quality analysis is based on a set of procedures and checks designed to ensure an accuracy, reliability, and overall quality of the geological model throughout its development and use. Geological models are used in advanced numerical and analytical solutions to solve intricacies of reservoir performance. Given a veracity, variety, and/or volume of data involved, geological modeling is a complex process. Generally, a geological reservoir evaluation process begins with an initial data acquisition, where a quality of seismic, well log, core sample, and/or other relevant data is assessed for accuracy and completeness. The process includes verifying a correctness of seismic interpretations, ensuring a structural model accurately reflects subsurface geology, and validating that property models are consistent with available well data and geological understanding. Additionally, the process can include checking geostatistical methods used for property distribution, reviewing grid quality to avoid computational errors in simulations, and calibrating the geological model against historical production data to enhance its predictive capability. Effective QC/QA of the geological model is needed to reduce uncertainties and increase confidence in model predictions to support informed decision-making in reservoir management and field development planning. Geological model QC/QA is a manual and time-consuming process even for small size reservoirs because there are multiple checks to be performed for each data input for each well. Furthermore, manual QC/QA is also prone to human error and in larger projects with numerous wells containing hundreds of well logs/tops is neither reliable nor practical.

A tool is disclosed herein that can be used to implement a process (a method) to evaluate a quality of a geological model. In some examples, the process can include generating stratigraphic well tops based on structure surfaces from grid per well along with actual well stratigraphic picks. Synthetic logs, core logs, and normal (e.g., formation, evaluation, and analysis (FAL)) logs can be generated in a standardized format. The process can be used to determine whether the geological model has adequate accuracy or fidelity in characterizing the reservoir. The process can include exporting model properties per zone and reservoir. Well and grid level data can be integrated at a zone and reservoir level. A user selected area of interest can be scanned for different geological properties (e.g., porosity, permeability, facies, saturation, etc.) and key performance indicators (KPIs) can be provided based on output of match quality. A dashboard can be provided by the tool to enable a user to visualize and interactively analyze data in 2D and/or 3D. Thus, the tool can be used for QC/QA of structural, stratigraphical and/or petrophysical features of geological models. The tool can be used to standardize 1D, 2D, and 3D data exported from reservoir software. The exported data can be stored in a database. The tool can compare exported data with actual measured data (e.g., at a well level) to generate metrics and KPIs to assess model quality.

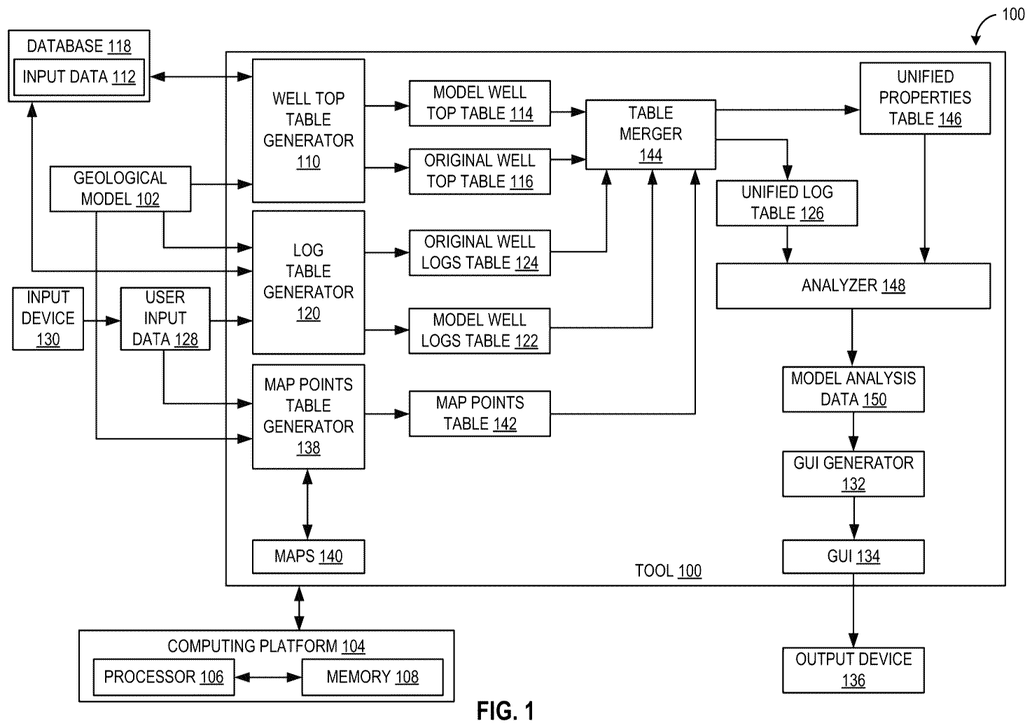

FIG. 1 is an example of a block diagram of a tool 100 for evaluating a quality of a geological model 102. In some examples, the geological model 102 is a geocellular model. The geological model 102 can represent one or more subsurface reservoirs and/or one or more wells. In some examples, the one or more wells can be represented in the geological model 102 by a trajectory, which details a path of the well through the one or more reservoirs which can include vertical, deviated and/or horizontal sections. For example, the geological model 102 can be a 3D geological model. Because a predictability of the geological model 102 depends on a quality of the geological model 102, a model quality the tool 100 can be used to validate the geological model 102 prior to an approval and/or use. Existing QA/QC processes of geological models are manual, subjective, and time-consuming processes. The tool 100 can be used to automate the QA/QC process by automating quality assurance workflows, and provide interactive displays, and identify areas where a quality of the geological model 102 can be improved. The tool 100 can be used to quantify, compare, and benchmark a quality of the geological model 102. In some examples, the tool 100 can be used to validate input data to identify data inconsistencies. The tool 100 can be used to validate the input data to assure structural integrity, logs quality, model property distribution (e.g., geological model property distribution), and/or volumetric estimates. Thus, the tool 100 can be used to automate a QA/QC process of the geological model 102 from data preparation to validation and reconciliation.

The tool 100 can be implemented using one or more modules, shown in block form in the drawings. The one or more modules can be in software or hardware form, or a combination thereof. In some examples, the tool 100 can be implemented as machine readable instructions for execution on a computing platform 104, as shown in FIG. 1. The computing platform 104 can include one or more computing devices selected from, for example, a desktop computer, a server, a controller, a blade, a mobile phone, a tablet, a laptop, a personal digital assistant (PDA), and the like.

The computing platform 104 can include a processor 106 and a memory 108. By way of example, the memory 108 can be implemented, for example, as a non-transitory computer storage medium, such as volatile memory (e.g., random access memory), non-volatile memory (e.g., a hard disk drive, a solid-state drive, a flash memory, or the like), or a combination thereof. The processor 106 can be implemented, for example, as one or more processor cores. The memory 108 can store machine-readable instructions (e.g., the tool 100) that can be retrieved and executed by the processor 106. Each of the processor 106 and the memory 108 can be implemented on a similar or a different computing platform. The computing platform 104 can be implemented in a cloud computing environment (for example, as disclosed herein) and thus on a cloud infrastructure. In such a situation, features of the computing platform 104 can be representative of a single instance of hardware or multiple instances of hardware executing across the multiple of instances (e.g., distributed) of hardware (e.g., computers, routers, memory, processors, or a combination thereof). Alternatively, the computing platform 104 can be implemented on a single dedicated server or workstation.

In some examples, the tool 100 can be implemented as part of or integrated into reservoir software or platform, but in other instances, can be implemented as a stand-alone application/software (e.g., and can be invoked by software, a program, a routine, in other instances, invoked by a user). Example reservoir software can include Petrel. Reservoir software allows for integration of data from various sources to create detailed representations of the subsurface corresponding to a geological model. Other software or programs can be used as well and the tool 100 can be integrated therein or interface with the software/program for use.

### Well Tops Data Generation

The tool 100 includes a well top table generator 110. The well top table generator 110 can provide a model (or synthetic) well top table 114 and an original well top table 116. A top refers to a boundary or interface separating distinct geologic units or layers in a subsurface. One type of top is a stratigraphic or chronostratigraphic top. This kind of top delineates a separation between layers (e.g., rock layers) that were deposited at different points in time. For instance, a stratigraphic top can mark the boundary between rock formations laid down during distinct geological periods, effectively separating older deposits from younger ones based on the time of their deposition. A well top refers to one or more depth points within a drilled well (borehole) where a boundary or interface is between distinct layers or formations. For example, this boundary can signify a change in the rock's characteristics, such as its composition, age, porosity, or other geological properties. Well tops can be used to map vertical and/or horizontal distribution of geological formations.

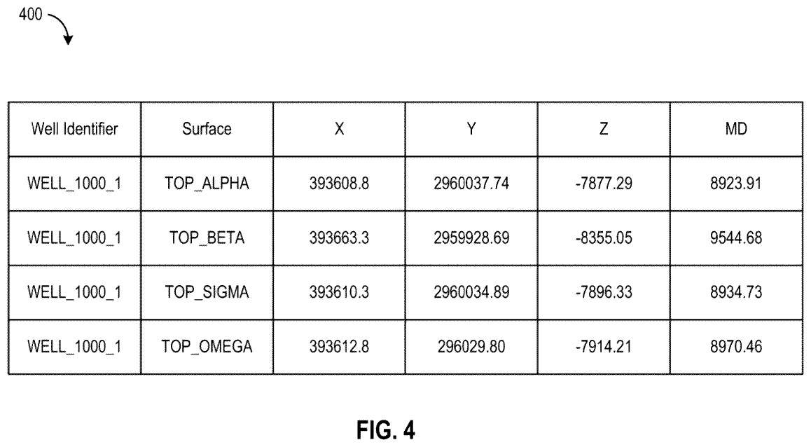

The model well top table 114 can be generated based on one or more horizons of the geological model 102. For example, the well top table generator 110 can identify more boundaries (e.g., top and/or bottom) of geological formations or stratigraphic units within the geological model 102. In some examples, a user can specify the geological boundaries and/or formation tops. A horizon represents a surface that delineates a top and/or bottom boundary of a geological formation or stratigraphic unit within a subsurface. The horizon in the geological model 102 can be represented as a continuous surface that can conform to a geometric shape and spatial distribution of a geological layer. The model well top table 114, for each well, can identify one or more well tops (e.g., stratigraphic well tops), a location of each well top, and a measured depth (MD). MD refers to a length of a borehole of a well measured along an actual well path from a reference point down to an end of the borehole, or any point of interest within the borehole. FIG. 4 is an example of a model well top table 400, which in some instances, can correspond to the model well top table 114, as shown in FIG. 1.

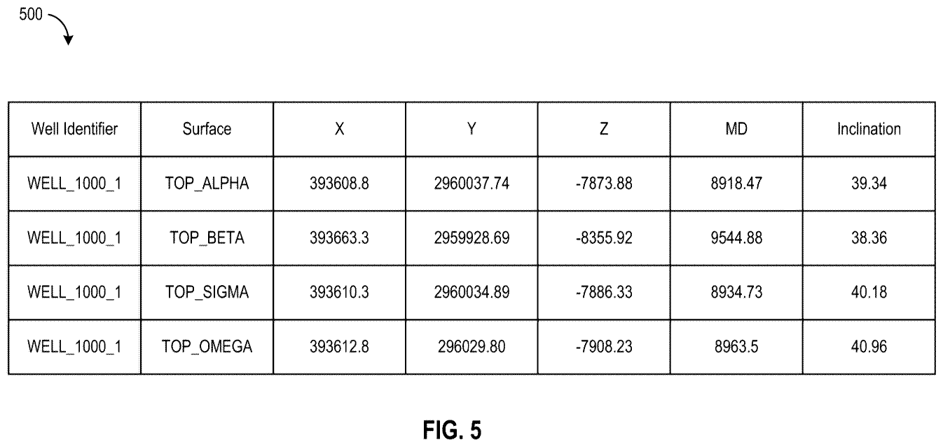

For example, the original well top table 116 can be generated based on input data 112, which can be stored in some instances in a database 118. In some examples, the input data 112 can be provided by reservoir software, in other examples, by a user, a different system or application. The input data 112 can include one or more of: well logs, seismic data, geological surveys, drilling reports, core sample data, etc. The well log data can include one or more normal logs and core logs. The original well top table 116, for each well, can identify one or more well picks (e.g., stratigraphic well picks), a location of each well pick, an MD and an inclination. FIG. 5 is an example of an original well top table 500, which can correspond to the original well top table 116, as shown in FIG. 1. A stratigraphic pick refers to an identification of a depth or point within a well log, seismic section, or geological dataset where a change in geological formation (e.g., in rock characteristics) can be observed. A stratigraphic well top is a type of stratigraphic pick that refers to an identified top boundary of a geological formation or layer encountered in a well. Inclination refers to an angle between a borehole's path and a vertical. The inclination is a measure of how much a well deviates from a straight down vertical path and can be expressed in degrees. Inclination is used for characterizing an orientation of the borehole at a depth where a well top is identified.

### Logs Data Generation

The tool 100 further includes a log table generator 120. The log table generator 120 can provide a model (or synthetic) well logs table 122 based on the geological model 102. For example, the log table generator 120 can generate synthetic logs based on grid properties (e.g., 3D grids properties) of the geological model 102. A grid of the geological model 102 represents a framework that divides a subsurface geological space into discrete, manageable units known as cells. Each cell within the grid contains data that can describe geological and/or petrophysical properties of that portion of the subsurface. These properties can be referred to as geological model properties or geological model property data. The type of information that can be stored within each cell (e.g., logically associated with that cell) can include one or more of lithology information, porosity information, permeability information, saturation information, pressure, and temperature information, and/or acoustic impedance. For example, the log generator 120 can extract geological model property data (e.g., one or more of permeability, facies, water saturation, etc.) from the grid properties. For example, the log generator 120 can access grid data (the grid properties) of the geological model 102 to extract the geological model property data. The grid data can include one or more of an effective porosity, permeability, facies, water saturation, etc. The log generator 120 can provide the model well logs table 122 based on the extracted geological model property data. The model well logs table 122 for each well can include different types of well property logs. For example, the model well logs table 122 can include an effective porosity log, a permeability log, a facies log, and/or a water saturation log. In some examples, the log table generator 120 can transform the model well logs table 122 into a format compatible with downstream data processing. For example, the log table generator 120 can provide the model well logs table 122 in a particular format, such as an American Standard Code for Information Exchange (ASCII) format.

In some examples, the log table generator 120 can provide an original well logs table 124 based on the input data 112. The log table generator 120 can provide the original well logs table 124 in a same format as the model well logs table 122. For example, the original well logs table 124 can include core logs and/or formation, evaluation, and analysis (FAL) logs, also known in some instances as normal logs. The FAL logs can include many types of different logs including, but not limited to, porosity logs, permeability logs, facies logs, and/or water saturation logs. Core logs can be generated from core samples extracted from the subsurface, for example, during drilling operations. Core logs provide physical measurements and/or characteristics of core properties, such as porosity, permeability, grain size, lithology, and/or fluid saturation. Core logs can be used to calibrate and/or validate other well logs and to provide ground truth data for reservoir modeling and simulation. Thus, core logs provide insight into geological and petrophysical properties of the reservoir rock. FAL logs are specialized well logs that provide detailed information about a formation (e.g., being drilled). FAL logs can include measurements of one or more various properties such as gamma ray, resistivity, density, neutron porosity, sonic velocity, and others. FAL logs can be used to evaluate the lithology, porosity, fluid content, and other petrophysical properties of the formation.

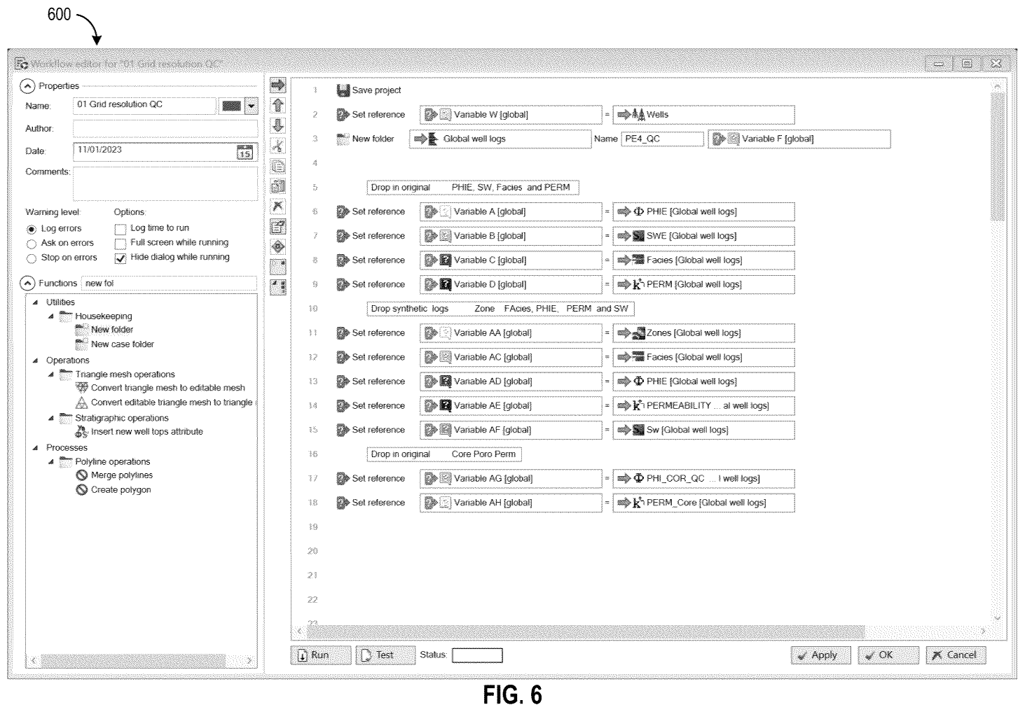

In some examples, the log table generator 120 can specify the type of log table that is provided to a table merger 144 based on user input data 128, which can be provided by an input device 130 (e.g., as disclosed herein). For example, the tool 100 can include a GUI generator 132 that can generate a GUI 134 for specifying the type of log table that is generated by the log table generator 120. The GUI 134 can be provided to an output device 136 (e.g., as disclosed herein). FIG. 6 is an example of a screen 600 of the GUI 134 that can be used by the user for controlling the types of well log tables that are provided to the table merger 144. A unique variable can be assigned to each parameter associated with 3D properties (e.g., lines 3-5 in the screen 600) and/or arial reservoir limit (e.g., line 3 in the screen 600), or any grid related surface.

### Maps and Points Data Generation

In some examples, the tool 100 includes a map points table generator 138. The map points table generator 138 can provide maps 140 based on the geological model 102. The maps 140 can be 2D maps that are generated based on 3D grid properties of the geological model 102. For example, the map points table generator 138 can provide the maps 140 based on grid properties per zone (or unit) of the geological model 102 to visually represent a spatial distribution of geological model properties. A geological zone or unit is a layer or section within a subsurface. Zones can be delineated by horizons. The 3D grid properties can include one or more of porosity, permeability, and/or water saturation, which can correspond to the geological model properties.

For example, the maps 140 can include net and/or average maps. A net map can represent a net value of a geological model property over a certain area or volume (e.g., a zone). An average map can represent an average value of a geological model property over a certain area or volume. For example, the map points table generator 138 can analyze per zone so that geological model properties of interest (e.g., porosity, permeability, and/or water saturation) can be calculated or summarized separately for each geological unit. The map points table generator 138 can iterate through each geological unit, calculate net and/or average values for specified geological model properties and create the maps 140 for each zone, as defined by the horizons. By generating these maps per zone, insights can be gained into how geological model properties vary not just spatially across the geological model 102 but also vertically through different geological layers.

In some examples, the map points table generator 138 can provide the maps 140 per reservoir of the geological model 102. For example, the map points table generator 138 can delineate each reservoir or reservoir layer within the geological model 102. In the case of stacked reservoirs, the map points table generator 138 can identify each layer that constitutes part of a stacked system. For example, the map points table generator 138 can access grid data of the geological model 102. The map points table generator 138 can extract the geological model property data (e.g., effective porosity, permeability, and/or water saturation) from the grid data for each identified reservoir. In some examples, the log table generator 120 stores the extracted geological model property data in the memory 108 and the map points table generator 138 retrieves this data from the memory 108.

In some examples, the map points table generator 138 can use a porosity threshold, which in some instances can be based on the user input data 128. The porosity threshold can be used to filter or classify porosity values. The porosity threshold is a threshold value or range that indicates good reservoir quality and potential for storing hydrocarbons. The map points table generator 138 can identify one or more reservoirs with a porosity that is high (e.g., greater than or equal to the high porosity threshold) and saturated with hydrocarbons. For each reservoir (or layer in stacked reservoirs), the map points table generator 138 calculates net and average values of geological model properties (e.g., porosity, permeability, and/or water saturation). In some instances, the net values can be measurements that meet specific criteria (e.g., that are above the porosity threshold and/or hydrocarbon saturation), whereas the average values can be calculated across an entire reservoir model. The map points table generator 138 can generate the maps 140 showing areas with high porosity, and areas with high porosity that also have significant hydrocarbon saturation.

For example, model attributes, such as PHIE (effective porosity), Perm (permeability), Sw (water saturation), Phi_H (porosity*thickness) can be validated in the QC process, as described herein. The net/average maps (the maps 14) can provide an overall representation of these attributes on zone by zone or reservoir basis. In some examples, an oil water contract (OWC) contract surface parameter can be used to limit the analysis to an oil zone (interest zone) to enhance an efficiency of the QC process. The model attributes can be compared by the tool 100 with measured values from well control on zone by zone or reservoir basis to identify any anomalies, as the modeled values of the attributes should fall within the range of measurements at well level.

In some examples, the map points table generator 138 can convert the maps 140 into individual points and provide the points in a map points table 142. For example, the maps 140 can be in a first format, and the map points table generator 138 can transform the maps 140 into another format, such as ASCII format, to provide the map points table 142. The map points table generator 138 can identify one or more locations and thus corresponding data from the maps 140 and extract a geological model property value for that location to provide the map points table 142. The geological model property value can include a net value and/or an average value for a geological model property. The locations selected from the maps 140 can be based on a predefined grid spacing or pattern that can be overlaid on the maps 140 or specific interest areas where points are needed. For example, the map points table generator 138 can create a grid overlay. In a non-limiting example, each cell of the grid overlay represents a 100 meter by 100 meter area. For each cell of the grid overlay, the map points table generator 138 can extract or identify one or more geological model property values for that portion of a map (e.g., within or associated with a cell). Each cell of the grid overlay can correspond to a point. The map points table generator 138 can extract relevant values from the net and/or average maps for that cell (data pint) that represent desired model geological properties. The map points table generator 138 can average the extracted relevant values to derive or compute an average extracted value. The map points table generator 138 can provide the map points table 142 based on the computed average extracted value for each point. Thus, the map points table 142 can identify a point corresponding to a portion of the map and its associated computed average extracted value.

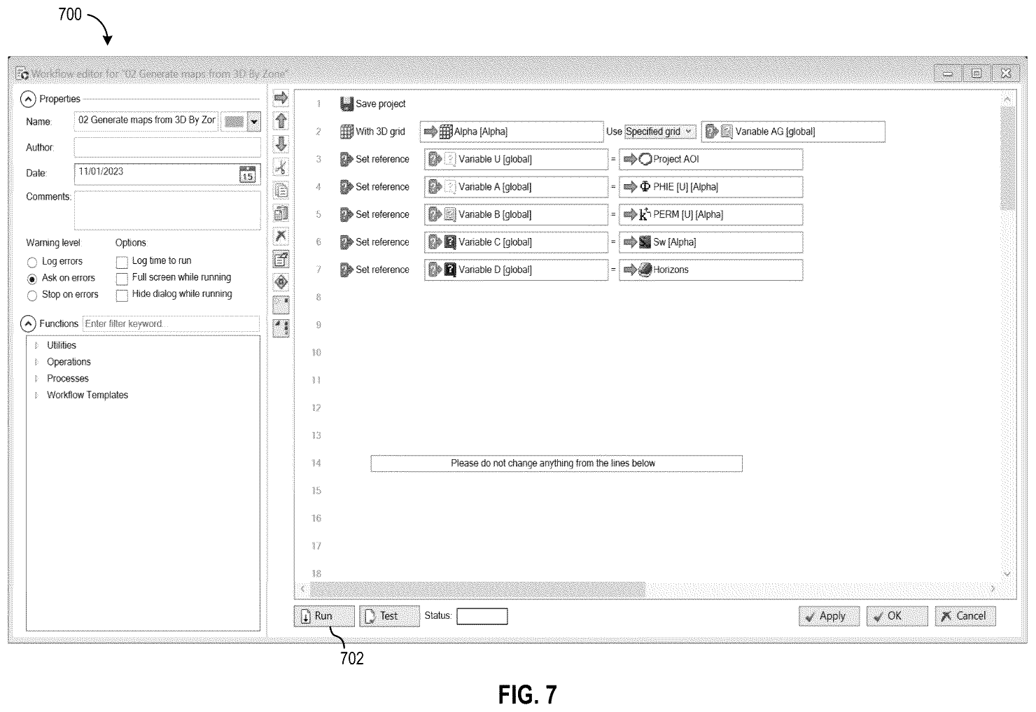

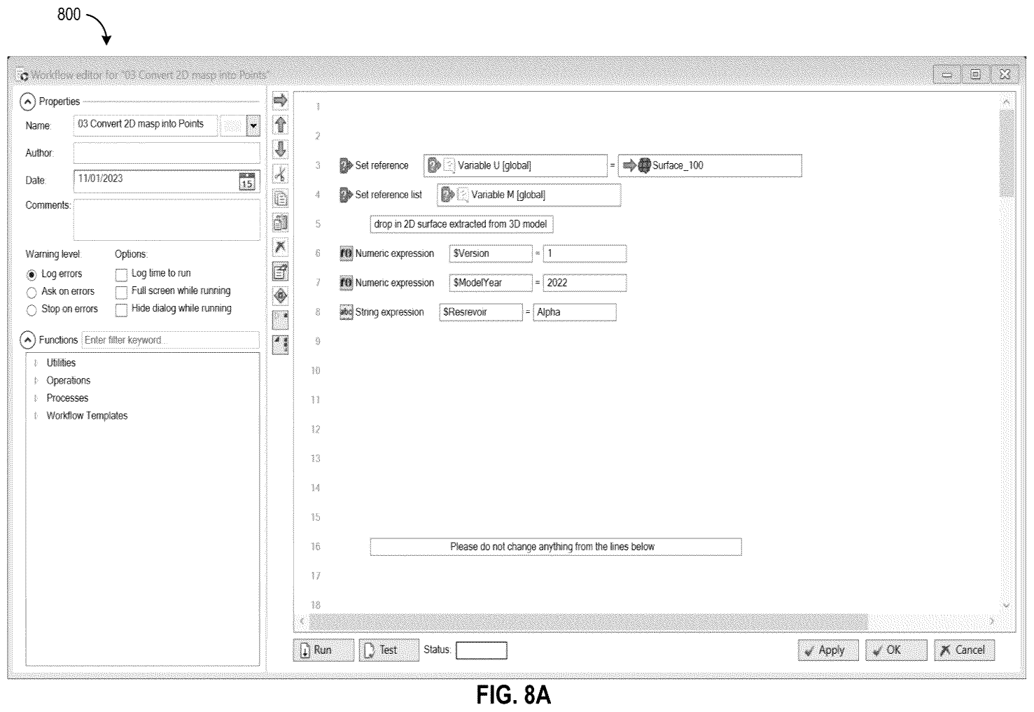

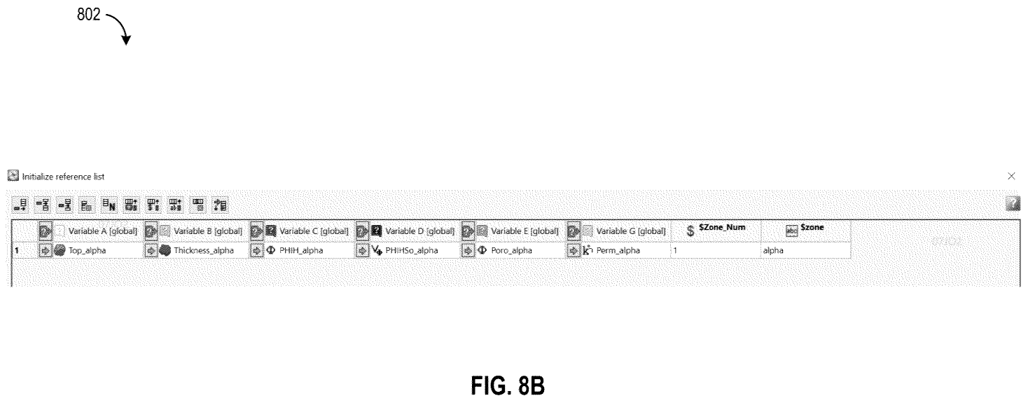

In some examples, the map points table generator 138 can provide the maps 140 based on the user input data 128. The user input data 128 can specify map and/or property types. FIG. 7 is an example of a screen 700 of the GUI 134 that can be provided by the GUI generator 132 to enable the user to provide the user input data 128. In some examples, the screen 700 includes a single button 702 that can be used to automate and initiate or execute with minimal user input generation of the maps 140 for the geological model 102. Upon the user interacting or engaging the single button 702, the map generator 132 can provide the map points table 142 according to one or more examples, as disclosed herein. FIG. 8A is an example of a screen 800 of the reservoir software GUI 134 relating to a workflow of converting 2D maps (the maps 140, or subset thereof) into points for providing the map points table 142. For example, the surface grid (e.g., line 3 in the example of FIG. 8A) is a 100×100 m. In line 4 of FIG. 8A, embedded maps can be converted into points, as shown in FIG. 8B, which is an example of a screen 802 of the reservoir software GUI 134.

### Data Table Merging

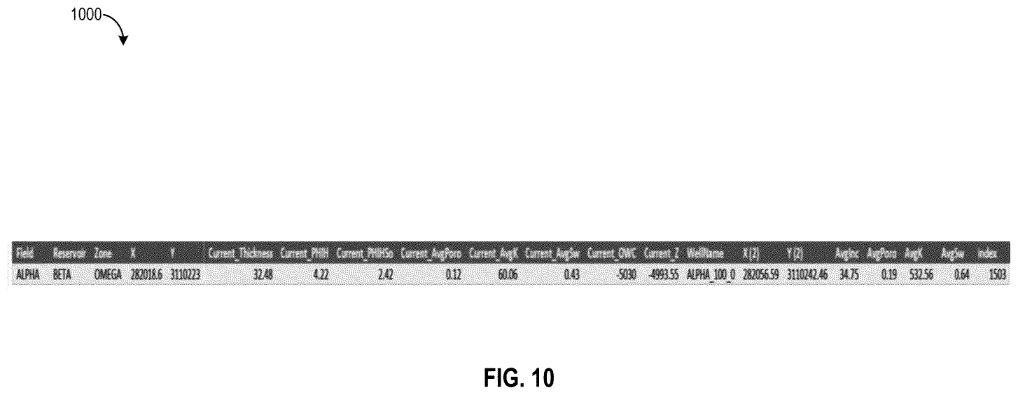

The tool 100 includes the table merger 144. In some examples, the table merger 144 can merge the model well logs table 122 and the original well logs table 124 into a unified log table 126. In additional or alternative examples, the table merger 144 can merge the model well top table 114, the original well top table 116, and the map points table 142 into a unified properties table 146. FIG. 10 is an example of a table 1000 corresponding to a portion of the unified properties table 146. For example, the table merger 144 can merge tables, for example, as disclosed herein, on a zone basis according to the following merge routine into a single dataset (table): right.columns=[‘Xm’, ‘Ym’] temp=pd.DataFrame([right[[“Xm”, “Ym”]].iloc[np.argmin(x)] for x in cdist(left [[‘X’, ‘Y’]], right[[‘Xm’,‘Ym’]])]).reset_index( ) output=pd.concat([left, temp], axis=1).

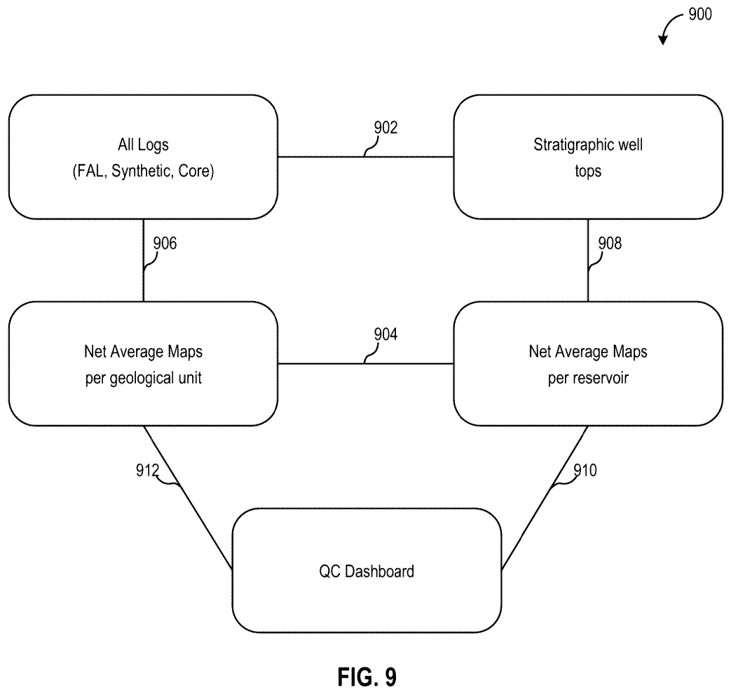

FIG. 9 is an example of a data integration diagram 900 showing logs, tops and map data being logically linked through the Tool 100, as shown in FIG. 1. The tool 100 makes this data ready for QC/QA analysis and visualizations, as disclosed herein. In the example of FIG. 9, lines 902-904 can represent connections (e.g., logical connections) between different datasets/tables based on one or more common attributes, such as a well identifier and/or zone. Lines 906-912 in the data integration diagram 900 can represent an integration of data into one or more unified tables, as disclosed herein. This integration allows for a seamless interaction with the data, where selecting a well (or another entity) in any part of the tool 100 aggregates and displays relevant data from across all linked tables or datasets.

### Quality Analysis of a Geological Model

For example, the tool 100 can include an analyzer 148 for evaluating a quality (accuracy) of the geological model 102. The analyzer 148 can be used to calculate one or more metrics and/or provide data (model analysis data 150) for visualizing the quality of the geological model 102 and thus the underlying data on which the model is based. For example, the analyzer 148 can analyze a structural integrity of the geological model 102 based on the unified log table 126. The analyzer 148 can compare a value of selected petrophysical properties (e.g., porosity, permeability, and/or water saturation) between logs (e.g., core, normal, and/or model logs) and rank mismatched wells based on quality prediction criteria. By way of a non-limiting example, the quality prediction criteria can be a root mean square error (RMSE). The analyzer 148 can compute for each well of the geological model 102 an RMSE value using the unified log table 126 and rank the wells according to computed RMSE values using the following expression: (Sqrt(Sum((${core.track}−${log.track})\hat{ }2)/(Count(${corc.track}))) as RMSE).

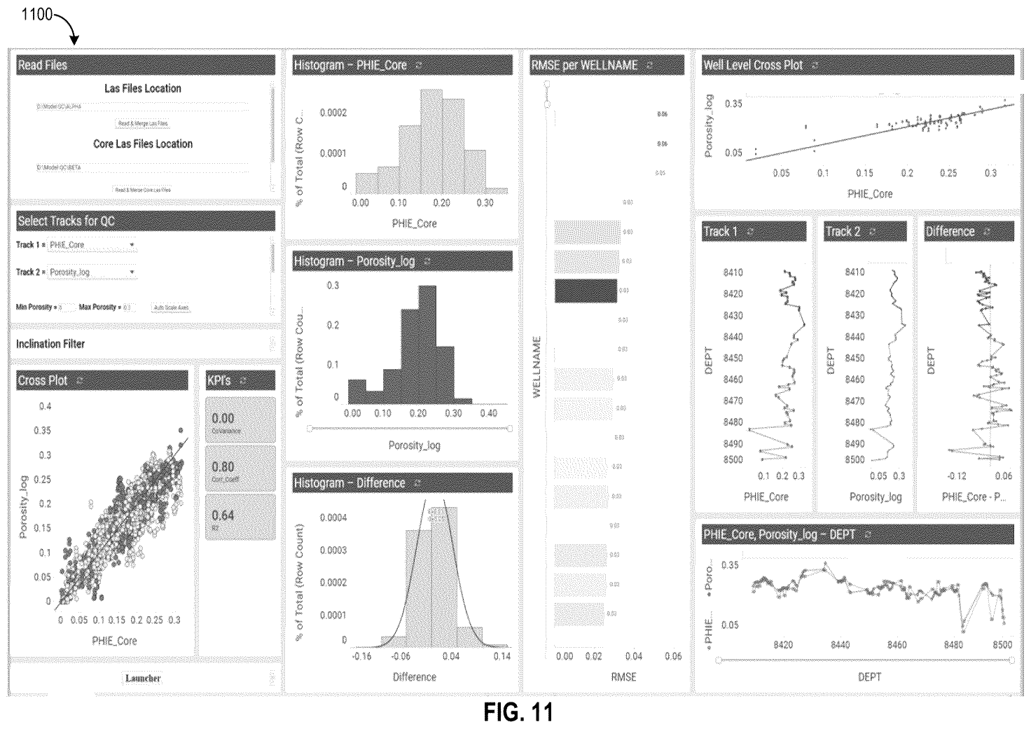

In some examples, the analyzer 148 can output the model analysis data 150 based on the analysis of the structural integrity of the geological model 102 using the unified log table 126. The model analysis data 150 can be used by the GUI generator 132 to provide the GUI 134. FIG. 11 is an example of a screen 1100 of the GUI 134 that can be provided by the GUI generator 132 based on the model analysis data 150 according to different types of analysis that can be implemented by the analyzer 148 for evaluating model quality or accuracy. For example, a window 1102 of the screen 1100 depicts the RMSE value for the ranked wells. An RMSE value can provide an indication of how well a structural integrity of the well has been modeled or captured by the geological model 102. Thus, a low RMSE value indicates a high degree of well structural integrity modeling. The screen 1100 can be a dashboard view where a user can perform logs analysis. All logs can be read and merged in a log table according to one or more examples, as disclosed herein. The logs tracks and zones of interest can be selected by the user based on which analysis plots are populated. The wells can be automatically ranked in order of higher to lower RMSE. Upon selecting a well from the RMSE per WellName column, an associated log track can be compared in the plots on its right side.

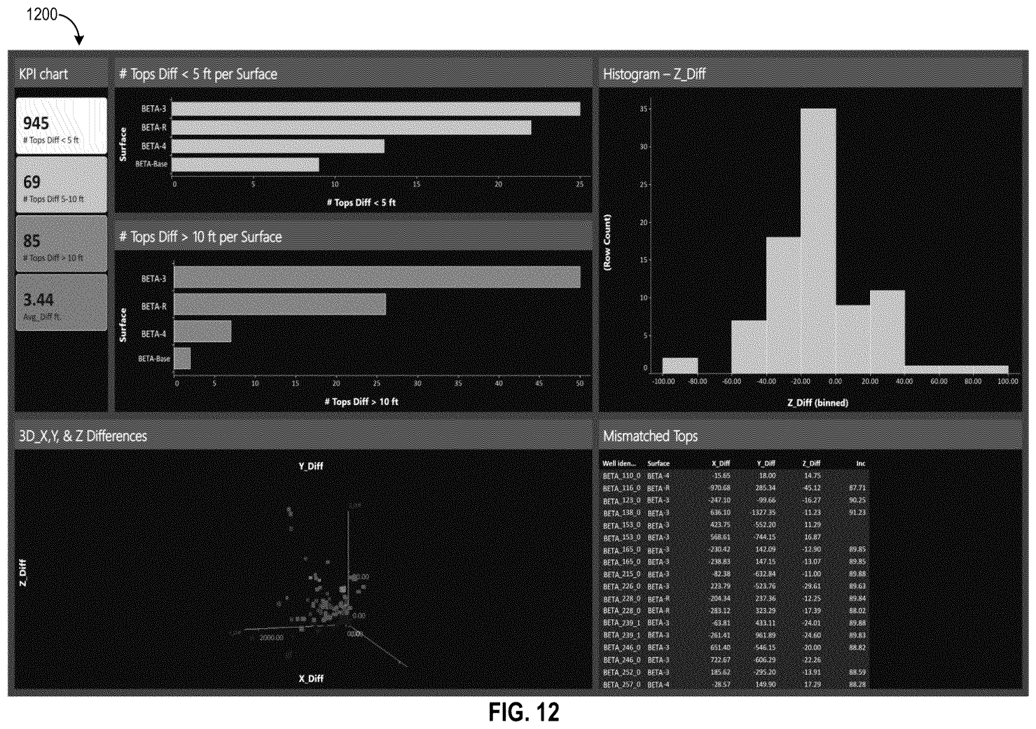

In some examples, the analyzer 148 can evaluate an accuracy and/or reliability of geological data that is being used for the geological model 102. For example, the analyzer 148 can compare model well tops with original well tops based on the unified properties table 146 to identify mismatching tops that can be provided as the model analysis data 150. The analyzer 148 can compute KPIs to visualize the comparison. The KPIs can indicate a number of well tops having a difference of less than 5 feet, a number of well tops having a difference between 5-10 feet, a number of well tops having a difference that is greater than 10 feet, and/or an average difference between the model well tops and the original well tops. The comparison can identify inconsistencies (or discrepancies) between the well of the geological model 102 and an actual well. For example, the analyzer 148 can compare the model well tops and the original well tops using the unified properties table 146 to identify any differences between the model well tops and the original well tops that are less than or equal to 5 feet, or greater than or equal to 10 feet. The GUI generator 132 can provide the GUI 134 based on the model analysis data 150 that identifies mismatched well tops, well tops with a difference less than 5 feet, well tops with a difference greater than 5 feet, the KIPs, and/or other information. FIG. 12 is an example of a screen 1200 of the GUI 134 depicting the model analysis data 150 comparing model well tops and the original well tops (e.g., stratigraphic well tops).

In some examples, the analyzer 148 can perform a statistical analysis to evaluate a vertical upscaling resolution of the geological model 102. The analyzer 148 can validate a vertical upscaling resolution of the geological model 102 to determine whether geological model properties assigned to cells (or locations) of the geological model 102 accurately represent geological properties observed in corresponding well data (e.g., the original well logs table 124 and/or other data) of the unified log table 126. Upscaling refers to a process of aggregating or averaging fine-scale geological properties into coarser-scale representations. This is often done to simplify a model while still preserving geological features and heterogeneities. Vertical upscaling resolution refers to a fidelity of geological features in a vertical direction while transitioning from a fine-scale representation to a coarser-scale representation. Geological models are typically structured in three dimensions, with cells representing volumes of the subsurface. These cells extend not only horizontally but also vertically, capturing stratigraphic layers and/or variations in geological properties that occur at different depths. When upscaling vertically, an objective is to aggregate or average fine-scale geological properties from multiple layers into coarser-scale representations while preserving characteristics of vertical heterogeneity. The analyzer 148 can implement a validation process to verify a reliability and accuracy of the geological model 102 in representing subsurface geology and thus the vertical upscaling resolution of the geological model 102.

For example, the analyzer 148 can evaluate the unified log table 126 by looping through corresponding model and original well log information/data therein to determine a flow capacity (e.g., cumulative horizontal permeability*thickness (cumulative kh)) and storage capacity (e.g., cumulative horizontal porosity*thickness (cumulative ϕh)) per one or more wells. The analyzer 148 can calculate a total horizontal permeability*thickness and porosity*thickness per each well and merge theses values with log tables. The analyzer 148 can calculate a fraction horizontal permeability*thickness and porosity*thickness per well. The analyzer 148 can sort by depth per well the fraction horizontal permeability*thickness and porosity*thickness and calculate the cumulative horizontal permeability*thickness (flow capacity) and the cumulative horizontal porosity*thickness (storage capacity). The Lorenz co-efficient of permeability variation is obtained by plotting a graph of cumulative kh vs cumulative phi*h also called as flow capacity plot. It is a measure used to assess reservoir heterogeneity.

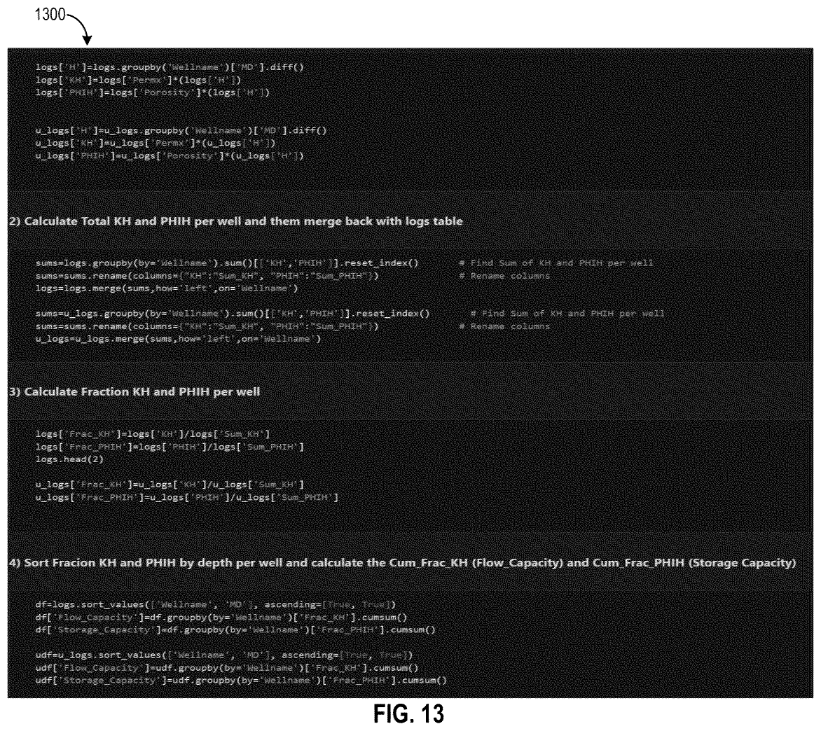

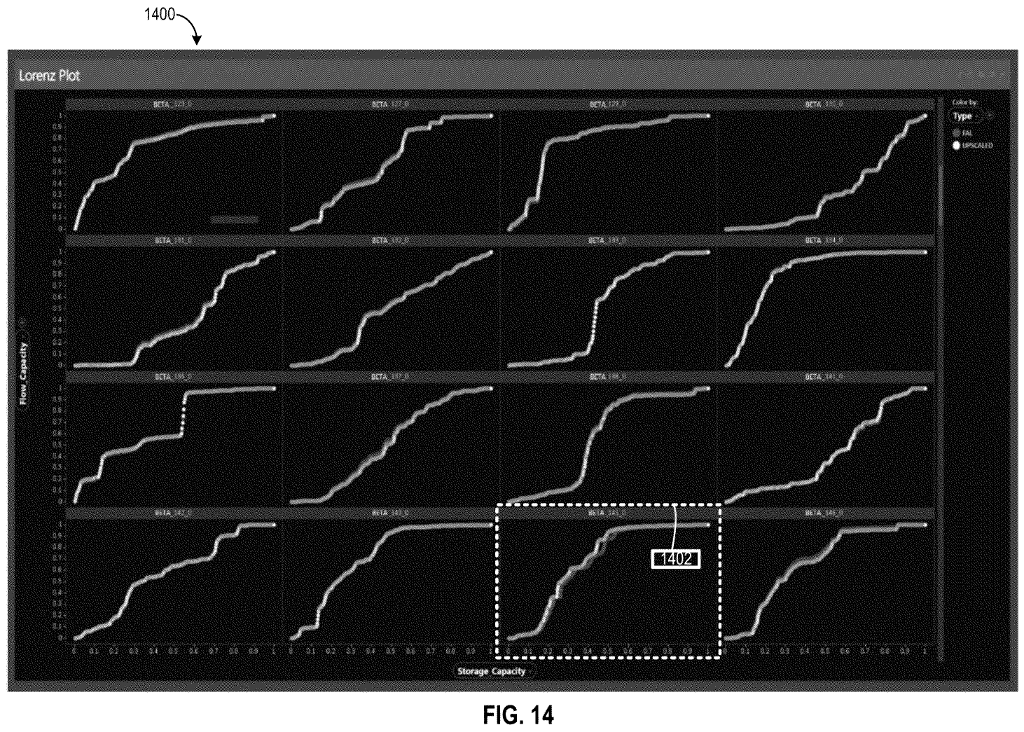

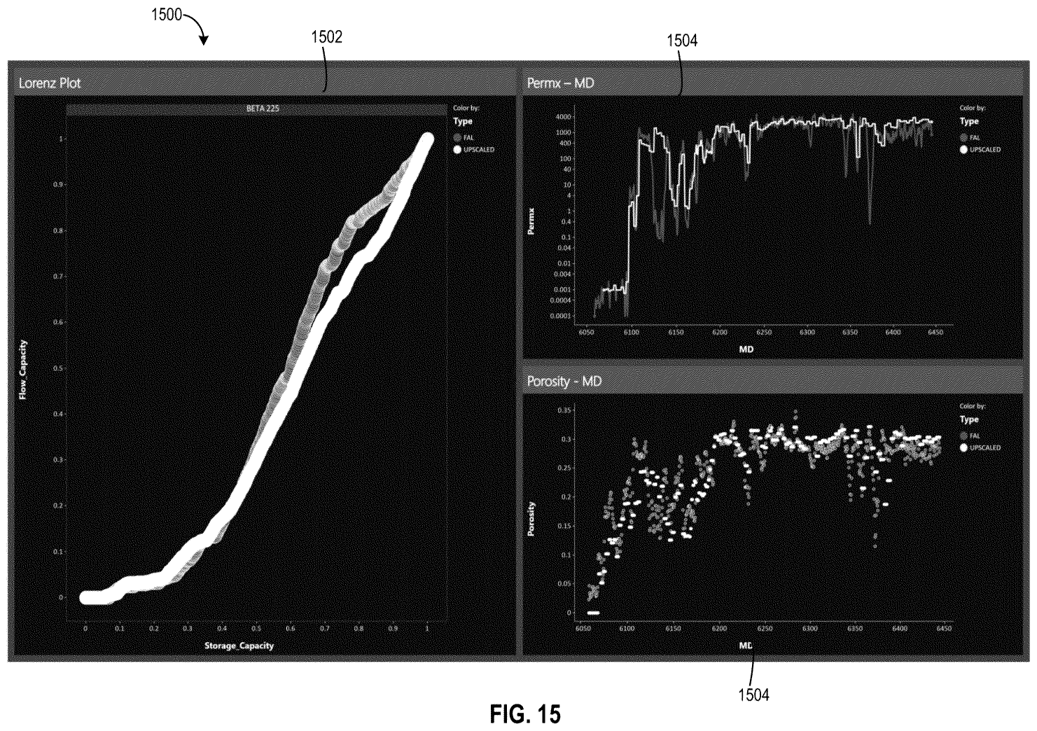

The cumulative horizontal permeability*thickness and porosity*thickness per well can be used for generating a cumulative plot, which can be provided as or as part of the model analysis data 150 in some instances. In a non-limiting example, the cumulative plot is a Lorenz plot. FIG. 13 is an example of a portion of pseudocode 1300 that can be used to provide the cumulative horizontal permeability*thickness and cumulative porosity*thickness per well for generation of Lorenz plots. The GUI generator 132 can use the model analysis data 150 to provide the GUI 134 with one or more Lorenz plots. FIG. 14 is an example of a screen 1400 of the GUI 134 with Lorenz plots. Each Lorenz plot on the screen 1400 can be for a respective well. Each Lorenz plot can include a first Lorenz curve and a second Lorenz curve. For each well, the first Lorenz curve characterizes a flow capacity with respect to a storage capacity for a well of the geological model 102 and the second Lorenz curve characterizes a flow capacity with respect to storage capacity for a corresponding actual well. In some examples, the first and second Lorenz curves can be compared by the analyzer 148 to evaluate the vertical upscaling resolution of the geological model 102 to detect a deviation between the first and second Lorenz curves that would imply that heterogeneity may not have been accurately preserved during upscaling such as shown in 1500. Ideally the total flow capacity and storage capacity from normal logs (FAL) and upscaled logs should overlay thus indicating that the heterogencity/flow barriers are preserved. The deviations imply that the barriers may not be accurately preserved such as at ˜6135 MD in FIG. 15 where FAL log is showing permeability of 0.1 md and synthetic log from upscaled model is showing permeability of 1000 md in view 1504. Thus, the analyzer 148 can identify discrepancies or inconsistencies between the geological model properties of the geological model 102 and actual geological properties to determine how well the geological model 102 represents one or more physical reservoirs (e.g., reservoir behavior). The GUI generator 132 can provide the GUI 134 with an indication of the discrepancy on the output device 136, which can be used to refine or improve the geological model 102, thereby improving a reliability of reservoir simulations and/or supporting effective reservoir management strategies.

In some examples, the GUI generator 132 can provide the GUI 134 with a screen 1500, as shown in FIG. 15. The screen 1500 can include a number of windows, such as a plot window 1502, a first profile window 1504, and a second profile window 1506. The plot window 1502 includes a Lorenz plot for a well identified as “Beta 225”, whereas the first profile window 1502 depicts a permeability profile (e.g., permeability-depth plot) and the second window 1504 depicts a porosity profile (e.g., porosity-depth plot). According to one or more examples disclosed herein, the analyzer 148 can identify a discrepancy for the well identified as “Beta 225” in FIG. 15. The permeability profile includes a first permeability curve and a second permeability curve. The porosity profile includes first porosity data values and second porosity data values. For example, the analyzer 148 can use one or more techniques (methods), as disclosed herein, to compare the first and second permeability curves and the first and second porosity values. Based on the comparison, a discrepancy can be detected according to one or more examples, as disclosed herein. For example, the analyzer 148 can detect a discrepancy between the first and second profiles, which can indicate that a permeability barrier was not accurately or not captured at all during upscaling. Thus, the analyzer 148 can determine that an upscaling process did not adequately account for a presence of characteristics of the permeability barrier. For example, consider a situation where a fault zone acts as a permeability barrier in the subsurface. At a fine scale, the original well logs can contain specific measurements and/or data characterizing a fault zone accurately. However, during the upscaling process, fine-scale details of the fault zone can be lost or simplified, resulting in a coarser-scale representation that fails to capture a barrier's presence or its impact on fluid flow dynamics. The failure to capture a permeability barrier in upscaling can lead to inaccuracies in simulations or predictions based on the geological model. For example, fluid flow can be incorrectly simulated as if the barrier does not exist, potentially leading to overestimation or underestimation of fluid movement, reservoir performance, and/or contaminant transport. The tool 100 can detect upscaling processes that do not accurately represent the geological properties in the resulting geological models and thus improve simulation and results.

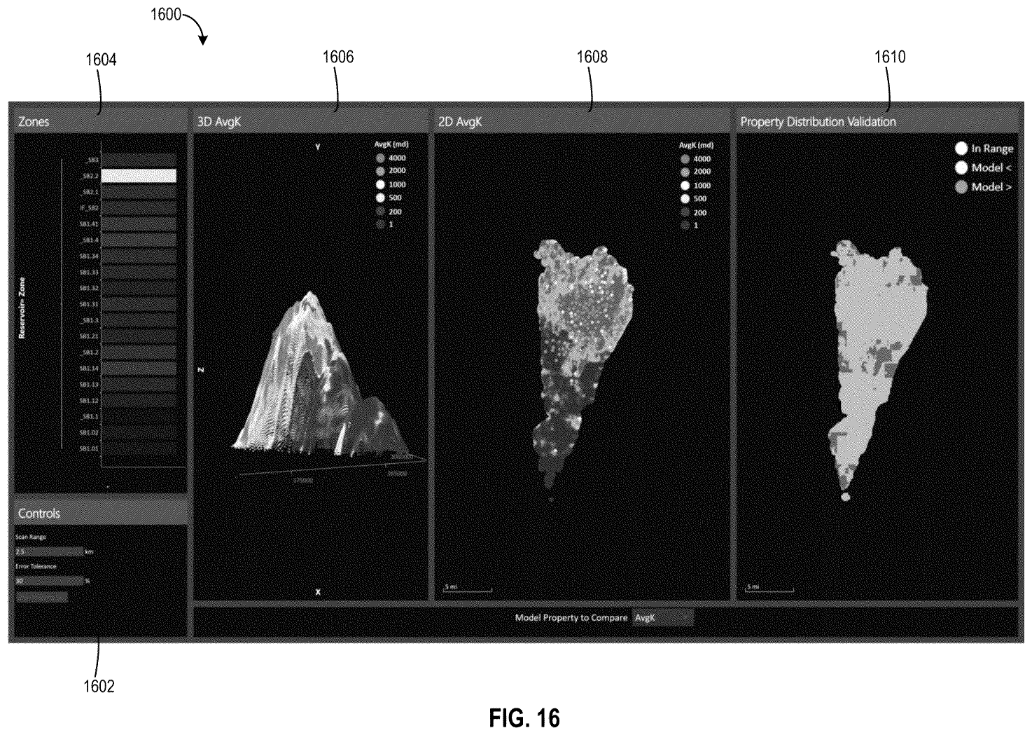

In some examples, the user can use the input device 130 to provide the user input data 128 that identifies a zone a geological property of interest (e.g., permeability, porosity, water saturation, facies (rock type or lithology), etc.), an input scan range, and/or an error tolerance. The input scan range is based on the variogram distance to populate the properties. The script scans the defined area around each cell comparing the average property from well measurements to the modeled value and colors the map based on values in range (Grey), >Model (Red) or <Model (Yellow). The user inputs error tolerance to allow for thresholds in the calculations. The zone can be a selected zone and identify a specific area or zone of the geological model 102. The analyzer 148 can use the user input data 128 and relevant unified properties data from the unified properties table 146 to identify areas where geological model properties of the geological model 102 are not consistent with well control data (e.g., information obtained from wells), such as for actual geological properties. In some examples, the analyzer 148 can provide the model analysis data 150 identifying the areas (or zones) of the geological model 102 that are not consistent with actual geological properties of a well. In some examples, the model analysis data 150 includes discrepancy data specifying the identified area of the geological model 102 that is not consistent with one or more corresponding wells. The discrepancy data can be mapped to a color scale and used for providing a discrepancy map, where geological model property data (the model geological properties) is within a wells range for a well, is highlighted as gray, where the geological model data is low and thus below a lower limit of the well range is highlighted as yellow, and where the geological model data is higher than an upper limit of the well range or offset well data, the area is highlighted as red. The GUI generator 132 can provide the GUI 134 with the discrepancy maps, as shown in FIG. 16.

FIG. 16 illustrates the GUI 134 with a window 1600 that includes a control window 1602, a scan window 1604, property map windows 1606-1608 showing selected property maps in 2D and 3D, and a discrepancy window 1610 with the discrepancy map. The legend in 1610 shows the colors on the image as an outcome of scan. In 1610. It is showing the results of permeability (AvgK) scan for zone SB2 with grey representing model cells in range of the measured values from wells. A color (e.g., red) can represent model cell values greater than the measure value from wells and another color (e.g., yellow) can represent model cells with less value than the wells. In the example of FIG. 16, the scan was performed in 2.5 km range around each cell comparing each average value with the value from well measurements. The property map window 1606 provides a 2D rendering of a geological property, and the property map window 1608 illustrates a 3D rendering of the geological property. These are 3D and 2D displays of selected property. The property is selected from the dropdown choice at the bottom. In 1600, Avg(K) is selected. However, it can be any property (Avg porosity, Avg Sw, Facies) etc. and it can be displayed automatically with colors distributed based on the range of properties. For example, a respective mismatch area 1612 on the discrepancy map can be identified in the mismatch window. The user can interact with graphical elements of the control window 1602 and the scan window 1604 to provide the user input data 128 that identifies a zone of interest, and the geological property of interest, an input scan range, and an error tolerance. For example, the tool 100 can identify identifies anomalies in properties distribution by performing a scan to compare attributes at well level with modeled values for visual comparison to assure there are no concentration of extreme values, which can be referred to as a bull's eye.

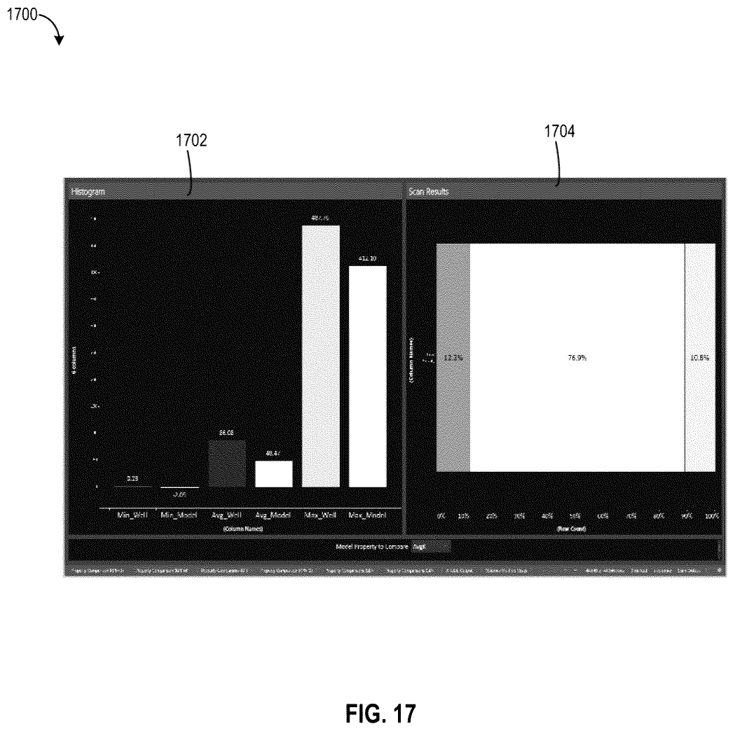

In some examples, the analyzer 148 can compute one or more statistics to show a comparison of minimum, maximum, and average geological model property values based on the unified properties table 146 for a zone (e.g., the selected zone) and one or more original geological properties. The analyzer 148 can output the model analysis data 150 with the computed statistics. The GUI generator 132 can provide the GUI 134 with the computed statistics. FIG. 17 is an example of a screen 1700 of the GUI 134 with a histogram window 1702 and a scan results window 1704 respectively providing statistics comparing model and actual/original geological property values.

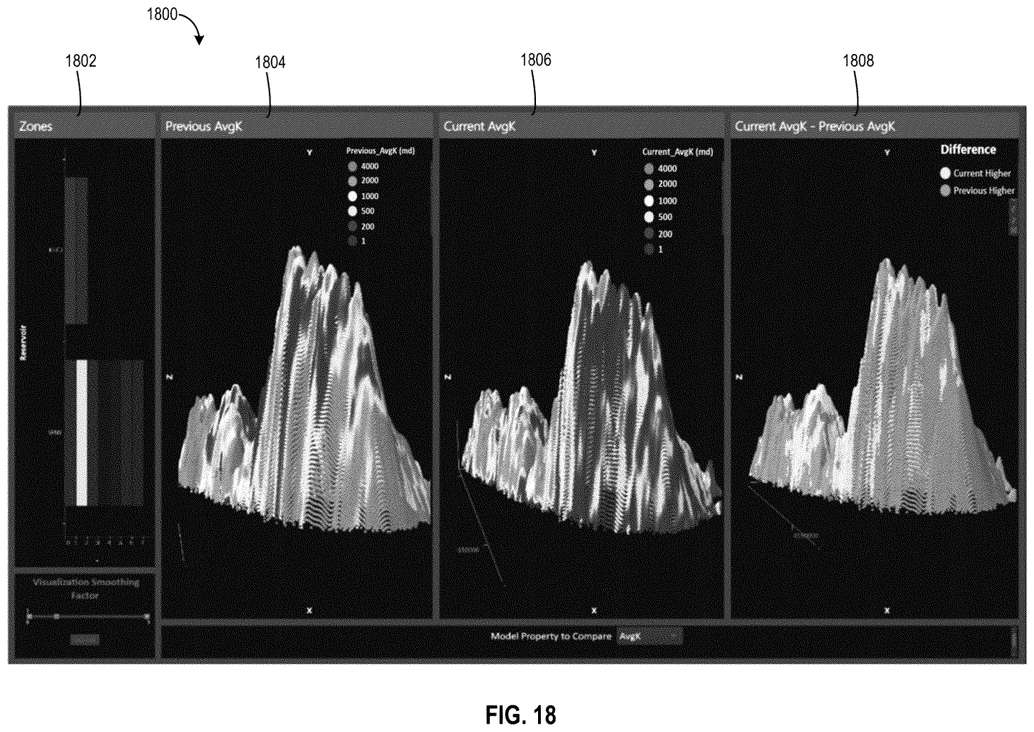

In some examples, the analyzer 148 can compare a current version of a geological model (e.g., the geological model 102) with a different version of the geological model 102, which can be a prior version or a future version using the unified properties table 146. The geological model comparison can be for a geological property of interest, as disclosed herein. The analyzer 148 can compare current and previous versions of the geological model 102 for any attributes of interest (e.g., geological property of interest) in either 2D or 3D and enable the user to visualize the geological properties in both versions as well as changes zone by zone. For example, the analyzer 148 can provide the model analysis data 150 with data for rendering geological property value maps so that the user can visualize a selected geological model property in previous and current versions of the geological model 102 as well as a difference between the previous and current version of the geological model 102 through magnitude variations. The GUI generator 132 can provide the GUI 134 based on the model analysis data 150 that includes a screen 1800, as shown in FIG. 18. The screen 1800 includes a zone window 1802, a previous window 1804, a current window 1806, and variation window 1808 for permeability, an average permeability. The zone window 1803 illustrates 3D representations of the model to compare multiple realizations and can help to understand where the changes in the models for the selected property arc. The previous window 1804 includes the previous version of the geological model 102 with a geological model property (its values) mapped according to a scale (e.g., color scale). The current window 1806 includes the current version of the geological model 102 with a geological model property mapped according to the scale. For example, if the scale is a color scale, areas where a model physical property value is lower can be in red and areas where the value is higher can be in green. The variation window 1808 includes the geological model 102 with magnitude variations indicating a difference between geological model property values of the previous and current versions of the geological model 102. The magnitude variations can be mapped to the scale to highlight higher and lower magnitude variations to the user, as shown in the variation window 1808.

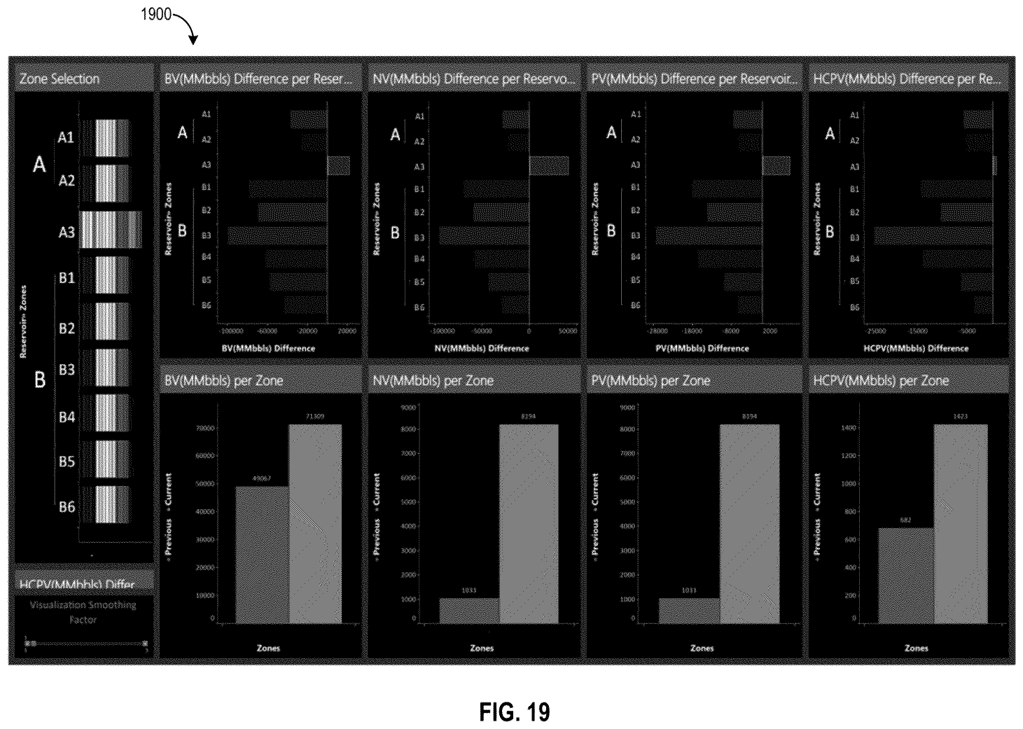

In some examples, the analyzer 148 can compare previous and current volumetrics to quantity changes for one or more reservoir parameters in the previous and current geological models. The one or more reservoir parameters can include bulk volume (e.g., a total volume of the reservoir rock, typically measured in cubic units (e.g., cubic meters or cubic feet), pore volume (e.g., a volume of the pore space within the reservoir rock, which may contain hydrocarbons or other fluids), hydrocarbon volume (e.g., a volume of the pore space containing hydrocarbons, which is relevant for estimating reserves and production potential), porosity height (e.g., the height or thickness of the reservoir interval with significant porosity (e.g., a depth range where fluid storage occurs)), and porosity height in oil zone (e.g., a height or thickness of the reservoir interval with significant porosity specifically within the oil-bearing zone.). The analyzer 148 can compare one or more of these reservoir parameters between the current and previous geological models, identify any differences, and quantify the differences (e.g., per reservoir and/or per zone). The analyzer 148 can provide the model analysis data 150 with the quantified differences. The GUI generator 132 can provide the GUI 134 with the quantified differences using the model analysis data 150. FIG. 19 is an example of a screen 1900 of the GUI 134 illustrating the quantified differences.

Accordingly, the tool 100 can be used to validate the quality of the geological model 102. In some examples, the geological model 102 can be updated or refined based on the analysis results data 150 so the geological model 102 more accurately predicts reservoir behavior. The geological model 102 can be used to inform decisions on well placement, production strategies, and/or field development planning. By way of further example, for validating the geological model 102, at an initial phase, the tool 100 can be used to prepare and output data in tables according to one or more examples, as disclosed herein. For example, the tool 100 can be used to generate and export stratigraphic well tops based on horizons from one or more models per well, export well stratigraphic picks based on the database 118, export normal, synthetic, and core logs, and generate model attributes (e.g., porosity, permeability, facies, and/or water saturation) and output on zone and reservoir basis (. The tool 100 can merge the normal, synthetic, and core logs and integrated model and well level properties data into a unified table on a zone basis. Using the unified tables herein, the tool 100 can calculate metrics and/or prepare visualizations for QA according to one or more examples, as disclosed herein. For example, the tool 100 can compare model tops with well tops and display a KPI chart with count and list of matching and mismatching tops. In some examples, the tool 100 can calculate Lorenz parameters and display flow capacity versus storage capacity plot well by well to validate vertical resolution. In some examples, the tool 100 can scan the geological model 102 based on a defined radius around each well and identify areas where 3D geological properties are not consistent with offset well data. Offset well data refers to information gathered from wells that are located near a particular well of interest, often within a certain radius or distance. These nearby or adjacent wells are called offset wells. The data from these wells is invaluable for several reasons, especially in the fields of oil and gas exploration, development, and production. Offset well data can include one or more of geological data, log data, production data, test data, etc. In additional or alternative examples, the tool 100 can be used to compare volumetrics between different realizations for bulk volume, pore volume, hydrocarbon pore volume in 2D plots as well as highlight variations in porosity and differences in porosity.

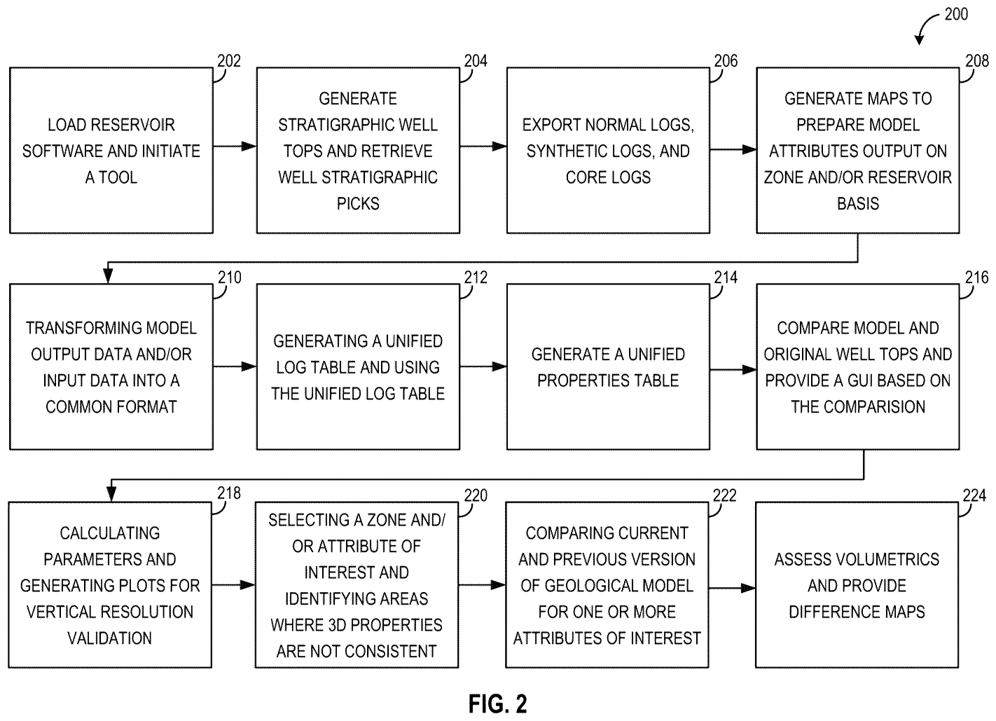

In view of the foregoing structural and functional features described above, an example method will be better appreciated with reference to FIG. 2. While, for purposes of simplicity of explanation, the example method of FIG. 2 is shown and described as executing serially, it is to be understood and appreciated that the present example is not limited by the illustrated order, as some actions could in other examples occur in different orders, multiple times and/or concurrently from that shown and disclosed herein. Moreover, it is not necessary that all described actions be performed to implement the method.

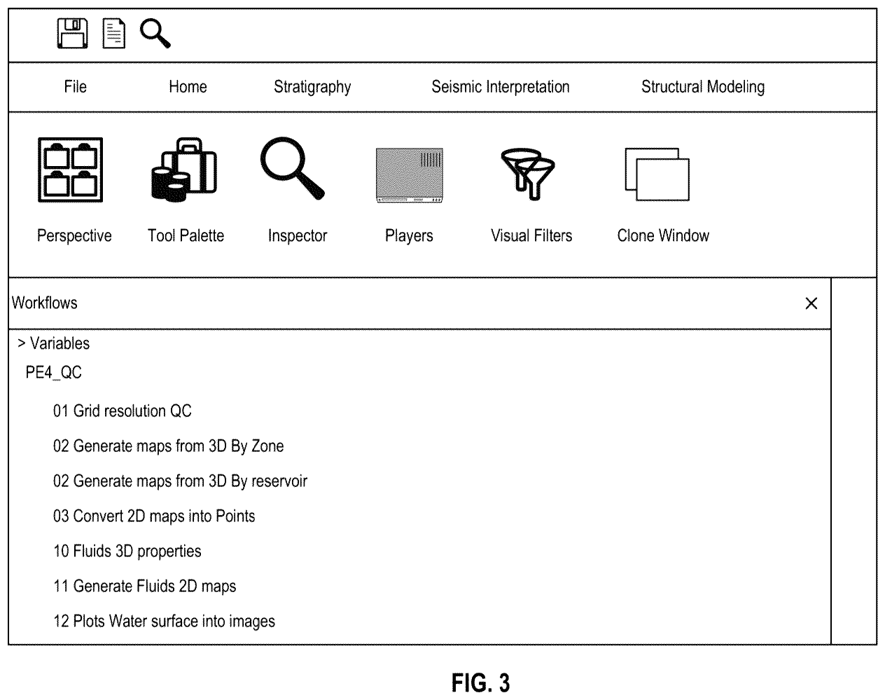

FIG. 2 is an example of a method 200 for evaluating an accuracy of a geological model, such as the geological model 102, as shown in FIG. 1. Thus, reference can be made to one or more examples of FIG. 1, and in some instances to FIGS. 3-19 in the example of FIG. 2. One or more steps of the method 200 can be implemented by the tool 100, as shown in FIG. 1. The method 200 can begin at 202 with loading the geological model into reservoir software. In some examples, at 202, the tool 100 can be loaded (e.g., by the reservoir software). For example, the tool 100 can include a number of workflows that can be executed by the reservoir software, or in response to a user. FIG. 3 is an example of a GUI 300 that can be provided by reservoir software identifying the workflows of the tool 100 for providing tables for model QA/QC analysis, such as disclosed herein. In some examples, the tool 100 is a software-plug for the reservoir software. At 204, stratigraphic well tops based on one or more horizons from the geological model per well can be generated in respective tables (model well and original well top tables, as disclosed herein). In some instances, at 204, the well stratigraphic picks can be retrieved (e.g., from the database 118) or provided. At 206, normal logs, synthetic logs, and core logs can be exported as tables for use by the tool 100 according to one or more examples, as disclosed herein. At 208, maps can be generated based on the geological model and used to prepare model attributes output on zone and/or reservoir basis. At 210, model output data and/or input data (e.g., one or more tops, logs, 3D properties, volumetrics, etc.) can be transformed into a common format (e.g., into tables).

In some examples, at 212, core, normal and synthetic log tables can be merged to provide a unified log table (e.g., the unified log table 126, as shown in FIG. 1). The unified log table can be used to evaluate a structural integrity of the geological model. At 214, model well and original well top tables and the map points table can be merged to provide a unified properties table (e.g., the unified properties table 146, as shown in FIG. 1) on a zone basis. At 216, model tops can be compared with original well tops using the unified properties table and GUI can be provided with a screen that includes a KPI chart with count and list of tops matching. At 218, for example, Lorenz parameters can be calculated by looping through normal and synthetic log data from the unified well log table and plots can be generated for vertical resolution validation. At 220, a zone and/or attribute of interest can be selected, and the tool 100 can identify areas where 3D properties are not consistent with well control data (e.g., information obtained from wells) for geological properties. At 222, a current and previous version of the geological model can be compared for one or more selected attributes of interest in both 2D and 3D to visualize the changes. At section 224, various instances of volumetric assessments can be compared, and an analysis of bulk volume, pore volume, hydrocarbon pore volume, as well as effective porosity and effective hydrocarbon saturation difference maps can be provided.

### Additional Exemplary Embodiments

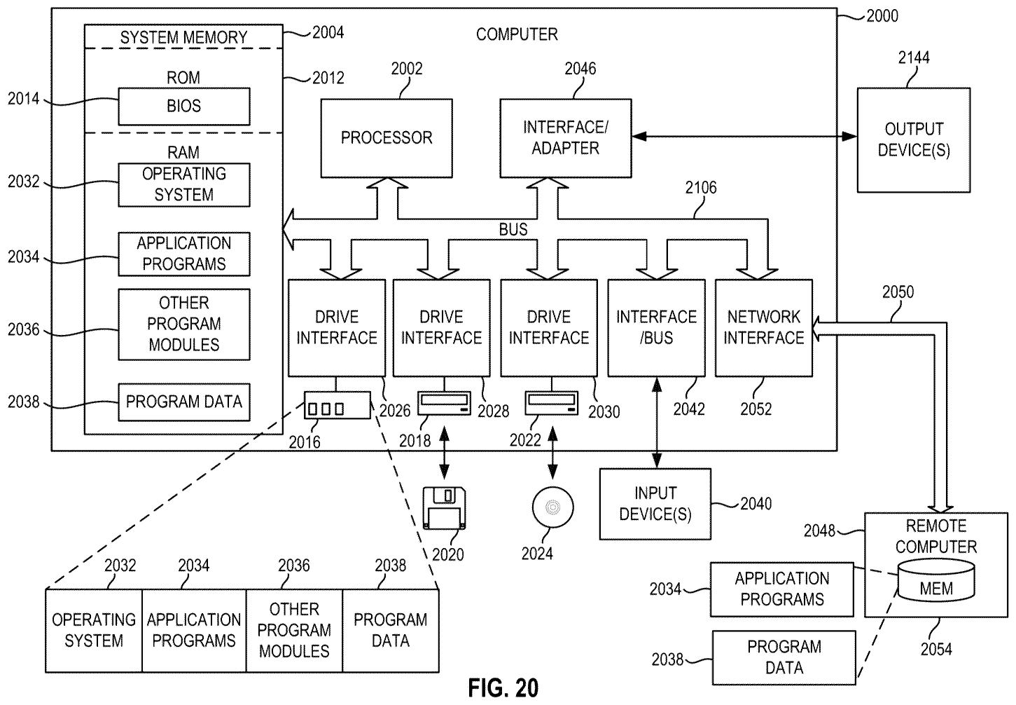

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 20. Thus, reference can be made to one or more examples of FIGS. 1-19 in the example of FIG. 20.

In this regard, FIG. 20 illustrates one example of a computer system 2000 that can be employed to execute one or more embodiments of the present disclosure. Computer system 2000 can be implemented on one or more general purpose networked computer systems, embedded computer systems, routers, switches, server devices, client devices, various intermediate devices/nodes, or standalone computer systems. Additionally, computer system 2000 can be implemented on various mobile clients such as, for example, a personal digital assistant (PDA), laptop computer, pager, and the like, provided it includes sufficient processing capabilities.

Computer system 2000 includes processing unit 2002, system memory 2004, and system bus 2006 that couples various system components, including the system memory 2004, to processing unit 2002. Dual microprocessors and other multi-processor architectures also can be used as processing unit 2002. System bus 2006 may be any of several types of bus structure including a memory bus or memory controller, a peripheral bus, and a local bus using any of a variety of bus architectures. System memory 2004 includes read only memory (ROM) 2010 and random access memory (RAM) 2012. A basic input/output system (BIOS) 2014 can reside in ROM 2012 containing the basic routines that help to transfer information among elements within computer system 2000.

Computer system 2000 can include a hard disk drive 2016, magnetic disk drive 2018, e.g., to read from or write to removable disk 2020, and an optical disk drive 2022, e.g., for reading CD-ROM disk 2024 or to read from or write to other optical media. Hard disk drive 2016, magnetic disk drive 2018, and optical disk drive 2022 are connected to system bus 2006 by a hard disk drive interface 2026, a magnetic disk drive interface 2028, and an optical drive interface 2030, respectively. The drives and associated computer-readable media provide nonvolatile storage of data, data structures, and computer-executable instructions for computer system 2000. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and disclosed herein. A number of program modules may be stored in drives and RAM 2010, including operating system 2032, one or more application programs 2034, other program modules 2036, and program data 2038. In some examples, the application programs 2034 can include one or more modules (or block diagrams), or systems, as shown and disclosed herein. Thus, in some examples, the application programs 2034 can include the tool 100, as shown in FIG. 1. In some examples, the application programs 2034 includes reservoir software, and the tool 100 can be implemented as part of the reservoir software, or interact with the reservoir software.

A user may enter commands and information into computer system 2000 through one or more input devices 2040, such as a pointing device (e.g., a mouse, touch screen), keyboard, microphone, joystick, game pad, scanner, and the like. These and other input devices are often connected to processing unit 2002 through a corresponding port interface 2042 that is coupled to the system bus, but may be connected by other interfaces, such as a parallel port, serial port, or universal serial bus (USB). One or more output devices 2044 (e.g., display, a monitor, printer, projector, or other type of displaying device) is also connected to system bus 2006 via interface 2046, such as a video adapter.

Computer system 2000 may operate in a networked environment using logical connections to one or more remote computers, such as remote computer 2048. Remote computer 2048 may be a workstation, computer system, router, peer device, or other common network node, and typically includes many or all the elements described relative to computer system 2000. The logical connections, schematically indicated at 2050, can include a local area network (LAN) and a wide area network (WAN). When used in a LAN networking environment, computer system 2000 can be connected to the local network through a network interface or adapter 2052. When used in a WAN networking environment, computer system 2000 can include a modem, or can be connected to a communications server on the LAN. The modem, which may be internal or external, can be connected to system bus 2006 via an appropriate port interface. In a networked environment, application programs 2034 or program data 2038 depicted relative to computer system 2000, or portions thereof, may be stored in a remote memory storage device 2054.

Although this disclosure includes a detailed description on a computing platform and/or computer, implementation of the teachings recited herein are not limited to only such computing platforms. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models (e.g., software as a service (Saas, platform as a service (PaaS), and/or infrastructure as a service (IaaS)) and at least four deployment models (e.g., private cloud, community cloud, public cloud, and/or hybrid cloud). A cloud computing environment can be service oriented with a focus on statelessness, low coupling, modularity, and semantic interoperability.

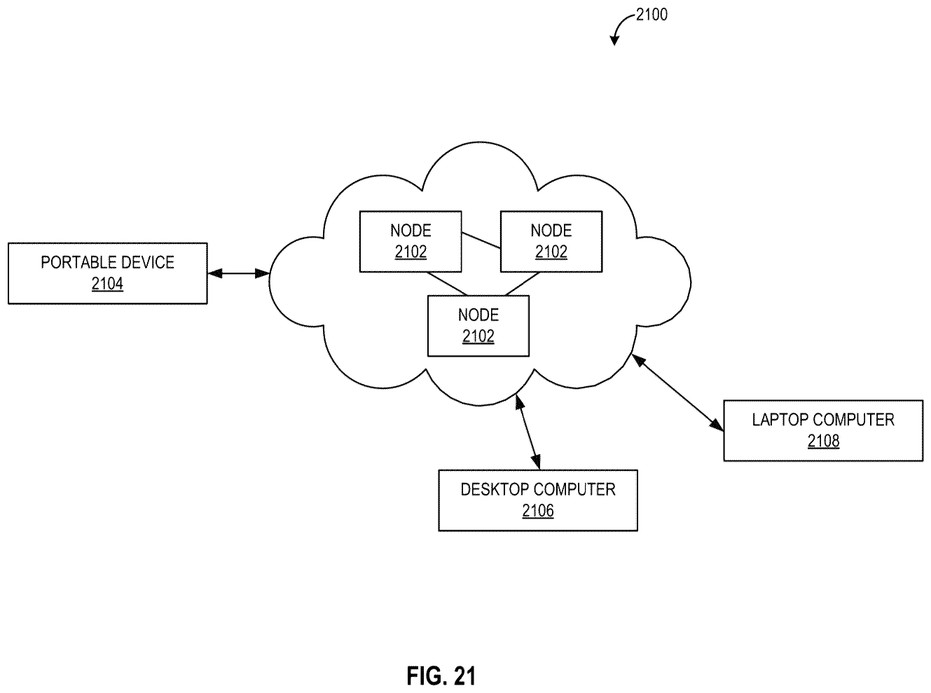

FIG. 21 is an example of a cloud computing environment 2100 that can be used for implementing one or more modules and/or systems in accordance with one or more examples, as disclosed herein. Thus, reference can be made to one or more examples of FIGS. 1-21 in the example of FIG. 21. As shown, cloud computing environment 2100 can include one or more cloud computing nodes 2102 with which local computing devices used by cloud consumers (or users), such as, for example, personal digital assistant (PDA), cellular, or portable device 2104, a desktop computer 2106, and/or a laptop computer 2108, may communicate. The computing nodes 2102 can communicate with one another. In some examples, the computing nodes 2102 can be grouped (not shown) physically or virtually, in one or more networks, such as Private, Community, Public, or Hybrid clouds, or a combination thereof. This allows the cloud computing environment 2100 to offer infrastructure, platforms and/or software as services for which a cloud consumer does not need to maintain resources on a local computing device. The devices 2104-2108, as shown in FIG. 21, are intended to be illustrative and that computing nodes 2102 and cloud computing environment 2100 can communicate with any type of computerized device over any type of network and/or network addressable connection (e.g., using a web browser). In some examples, the one or more computing nodes 802 are used for implementing one or more examples disclosed herein relating to root-source identification. Thus, in some examples, the one or more computing nodes can be used to implement modules, platforms, and/or systems, as disclosed herein.

In some examples, the cloud computing environment 2100 can provide one or more functional abstraction layers. It is to be understood that the cloud computing environment 2100 need not provide all of the one or more functional abstraction layers (and corresponding functions and/or components), as disclosed herein. For example, the cloud computing environment 2100 can provide a hardware and software layer that can include hardware and software components. Examples of hardware components include mainframes; RISC (Reduced Instruction Set Computer) architecture-based servers; servers; blade servers; storage devices; and networks and networking components. In some embodiments, software components include network application server software and database software.

In some examples, the cloud computing environment 2100 can provide a virtualization layer that provides an abstraction layer from which the following examples of virtual entities may be provided: virtual servers; virtual storage; virtual networks, including virtual private networks; virtual applications and operating systems; and virtual clients. In some examples, the cloud computing environment 2100 can provide a management layer that can provide the functions described below. For example, the management layer can provide resource provisioning that can provide dynamic procurement of computing resources and other resources that are utilized to perform tasks within the cloud computing environment. The management layer can also provide metering and pricing to provide cost tracking as resources are utilized within the cloud computing environment 2100, and billing or invoicing for consumption of these resources. In one example, these resources may include application software licenses. Security provides identity verification for cloud consumers and tasks, as well as protection for data and other resources. The management layer can also provide a user portal that provides access to the cloud computing environment 2100 for consumers and system administrators. The management layer can also provide service level management, which can provide cloud computing resource allocation and management such that required service levels are met. Service Level Agreement (SLA) planning and fulfillment can also be provided to provide pre-arrangement for, and procurement of, cloud computing resources for which a future requirement is anticipated in accordance with an SLA.

In some examples, the cloud computing environment 2100 can provide a workloads layer that provides examples of functionality for which the cloud computing environment 2100 may be utilized. Examples of workloads and functions which may be provided from this layer include mapping and navigation; software development and lifecycle management; virtual classroom education delivery; data analytics processing; and transaction processing. Various embodiments of the present disclosure can utilize the cloud computing environment 2100.

The present disclosure is also directed to the following exemplary embodiments, which can be practiced in any combination thereof:
Embodiment 1: a method for evaluating a quality of a geological model of a reservoir comprising: generating, by a processor, a model well top table based on a horizon of the geological model; generating, by the processor, an original well top table based on input data comprising normal logs and formation, evaluation, and analysis (FAL)) logs for the reservoir; merging, by the processor, the model well top table and the original well top table to provide a unified properties table; and evaluating, by the processor, the quality of the geological model using the unified properties table.
Embodiment 2: a method for evaluating a quality of a geological model of a reservoir comprising: generating, by a processor, a model well logs table based on the geological model; generating, by the processor, an original well logs table based on logs captured for the reservoir; merging, by the processor, the model well logs table and the original well logs table to provide a unified log table; and evaluating, by the processor, the quality of the geological model using the unified log table.
Embodiment 3: a system comprising: a tool comprising: a map points table generator to generate a map points table based one or more maps provided based on the geological model a well top table generator to: generate a model well top table based on the geological model; generate an original well top table based on input data; a log table generator to: generate a model well logs table based on the geological model; generate an original well logs table based on logs captured for the reservoir; a table merger to: merge the model well top table, the original well top table and the map points table to provide a unified properties table; merge the model well logs table and the original well logs table to provide a unified log table; an analyzer to evaluate a quality of the geological model using one of the unified properties table and the unified log table and provide analysis results data; and a graphical user interface (GUI) generator to provide a GUI based on the analysis results data for rendering on an output device. further comprising,

Each of embodiments A through C may have one or more of the following additional elements in any combination: Element 1: generating, by the processor, analysis results data based on the evaluation and rendering the analysis results data on an output device; Element 2: refining, by the processor, the geological model based on the analysis results data; Element 3: generating, by the processor, a map points table based one or more maps provided based on the geological model, wherein the merging comprises merging well properties to provide the unified properties table; Element 4: wherein the one or more maps include average and net maps for one or more geological model properties of the geological model; Element 5: generating, by the processor, a model well logs table based on the geological model; generating, by the processor, an original well logs table based on logs captured for the reservoir; and merging, by the processor, the model well logs table and the original well logs table to provide a unified log table, wherein the quality of the geological model is further evaluated at well level based on the unified log table; Element 6: wherein the model well top table is generated by identifying points within the geological model that align with geological boundaries or formation tops; Element 7: wherein the model well top table identifies for each modeled well of the geological model one or more well tops a location of each well top, and a measured depth; Element 8: wherein the original well top table identifies for each well of the reservoir one or more well picks, a location of each well pick, a measured depth, and an inclination; Element 9: generating, by the processor, analysis results data based on the evaluation and rendering the analysis results data on an output device; Element 10: refining, by the processor, the geological model based on the analysis results data; Element 11: generating, by the processor, a model well top table based on the geological model; generating, by the processor, an original well top table based on input data; and merging, by the processor, the model well top table and the original well top table to provide a unified properties table, wherein the quality of the geological model is further evaluated based on the unified properties table; Element 12: generating, by the processor, a map points table based one or more maps provided based on the geological model, wherein the merging comprises merging the model well top table, the original well top table, and the map points table to provide the unified properties table; Element 13: wherein the one or more maps include average and net maps for one or more geological model properties of the geological model; Element 14: wherein the tool is to identify anomalies in properties distribution by performing a scan to compare attributes at well level with modeled values for visual comparison to assure there are no concentration of extreme values; Element 15: wherein: the model well top table identifies for each modeled well of the geological model one or more well tops a location of each well top, and a measured depth; the input data comprises one or more of well logs, geological properties, and core sample data; the original well top table identifies for each well of the reservoir one or more well picks, a location of each well pick, a measured depth, and an inclination; and the one or more maps include average and net maps for one or more geological model properties of the geological model; Element 16: wherein the tool is loaded into a reservoir software and executed to allow for automated quality evaluation of the geological model; and Element 17: wherein the geological model is refined based on the analysis results data and used to inform decisions on well placement, production strategies, and/or field development planning.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or carry out combinations of special purpose hardware and computer instructions.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such. Furthermore, to the extent that the terms “includes,” “has,” “possesses,” and the like are used in the detailed description, claims, appendices, and drawings such terms are intended to be inclusive in a manner similar to the term “comprising” as “comprising” is interpreted when employed as a transitional word in a claim. The term “based on” means “based at least in part on.” The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 5-10% of the indicated number.

What has been described above includes mere examples of systems, computer program products and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

The invention claimed is:

1. A method for evaluating a quality of a geological model of a reservoir comprising:
generating, by a processor, a model well top table based on a horizon of the geological model;
generating, by the processor, an original well top table based on input data comprising normal logs and formation evaluation and analysis (FAL)) logs for the reservoir;
merging, by the processor, the model well top table and the original well top table to provide a unified properties table; and
evaluating, by the processor, the quality of the geological model using the unified properties table.

2. The method of claim 1, further comprising generating, by the processor, analysis results data based on the evaluation and rendering the analysis results data on an output device.

3. The method of claim 1, refining, by the processor, the geological model based on the analysis results data.

4. The method of claim 1, further comprising generating, by the processor, a map points table based one or more maps provided based on the geological model, wherein the merging comprises merging well level properties, and the map points table to provide the unified properties table.

5. The method of claim 4, wherein the one or more maps include average and net maps for one or more geological model properties of the geological model.

6. The method of claim 1, further comprising:
generating, by the processor, a model well logs table based on the geological model;
generating, by the processor, an original well logs table based on logs captured for the reservoir; and
merging, by the processor, the model well logs table and the original well logs table to provide a unified log table, wherein the quality of the geological model is further evaluated at well level based on the unified log table.

7. The method of claim 1, wherein the model well top table is generated by identifying points within the geological model that align with geological boundaries or formation tops.

8. The method of claim 1, wherein the model well top table identifies for each modeled well of the geological model one or more well tops at a location of each well top, and a measured depth.

9. The method of claim 1, wherein the original well top table identifies for each well of the reservoir one or more well picks, a location of each well pick, a measured depth, and an inclination.

10. A method for evaluating a quality of a geological model of a reservoir comprising:
generating, by a processor, a model well logs table based on the geological model;
generating, by the processor, an original well logs table based on logs captured for the reservoir;
merging, by the processor, the model well logs table and the original well logs table to provide a unified log table; and
evaluating, by the processor, the quality of the geological model using the unified log table.

11. The method of claim 10, further comprising generating, by the processor, analysis results data based on the evaluation and rendering the analysis results data on an output device.

12. The method of claim 10, refining, by the processor, the geological model based on the analysis results data.

13. The method of claim 10, further comprising:
generating, by the processor, a model well top table based on the geological model;
generating, by the processor, an original well top table based on input data; and
merging, by the processor, the model well top table and the original well top table to provide a unified properties table, wherein the quality of the geological model is further evaluated based on the unified properties table.

14. The method of claim 13, further comprising generating, by the processor, a map points table based one or more maps provided based on the geological model, wherein the merging comprises merging the model well top table, the original well top table, and the map points table to provide the unified properties table.

15. The method of claim 14, wherein the one or more maps include average and net maps for one or more geological model properties of the geological model.

16. A system comprising:
a tool comprising:
a map points table generator to:
generate a map points table based one or more maps provided based on the geological model
a well top table generator to:
generate a model well top table based on the geological model;
generate an original well top table based on input data;
a log table generator to:
generate a model well logs table based on the geological model;
generate an original well logs table based on logs captured for the reservoir;
a table merger to:
merge the model well top table, the original well top table and the map points table to provide a unified properties table;
merge the model well logs table and the original well logs table to provide a unified log table;
an analyzer to evaluate a quality of the geological model using one of the unified properties table and the unified log table and provide analysis results data; and
a graphical user interface (GUI) generator to provide a GUI based on the analysis results data for rendering on an output device.

17. The system of claim 16, wherein the tool is to identify anomalies in properties distribution by performing a scan to compare attributes at well level with modeled values for visual comparison to assure there are no concentration of extreme values.

18. The system of claim 16, wherein:
the model well top table identifies for each modeled well of the geological model one or more well tops a location of each well top, and a measured depth;
the input data comprises one or more of well logs, geological properties, and core sample data;
the original well top table identifies for each well of the reservoir one or more well picks, a location of each well pick, a measured depth, and an inclination; and
the one or more maps include average and net maps for one or more geological model properties of the geological model.

19. The system of claim 16, wherein the tool is loaded into a reservoir software and executed to allow for automated quality evaluation of the geological model.

20. The system of claim 16, wherein the geological model is refined based on the analysis results data and used to inform decisions on well placement, production strategies, and/or field development planning.
